(19) United States
(12) Patent Application Publication
(10) Pub. No.: US 2026/0312450 A1
(43) Pub. Date: Oct. 8, 2026

(54) IMPROVEMENTS RELATING TO COOLING OF ELECTRIC MACHINES

(71) Applicant: Vestas Wind Systems A/S, Aarhus N. (DK)

(72) Inventors: Peter P. Mongeau, Center Conway, NH (US); Jan-Dirk Bremer, Ahrensbök (DE)

(73) Assignee: Vestas Wind Systems A/S, Aarhus N. (DK)

(21) Appl. No.: 19/484,413

(22) PCT Filed: May 3, 2024
(86) PCT No.: PCT/DK2024/050105

§ 371 Date: Nov. 14, 2025

Related U.S. Application Data
(60) Provisional application No. 63/502,725, filed on May 17, 2023.

(30) Foreign Application Priority Data
Jul. 3, 2023 (DK) PA 2023 70351

(51) Int. Cl. H02K 1/32; H02K 3/22; H02K 7/18; H02K 17/20

(52) U.S. Cl. CPC H02K 1/32; H02K 3/22; H02K 7/1838; H02K 17/20

(57) ABSTRACT

An electric machine comprising a rotor including a plurality of hollow conductor bars adapted for carrying cooling fluid therein, the conductor bars extending between first and second short circuit rings. At least one of the short circuit rings is adapted to provide an annular sump volume that feeds cooling fluid to at least some of the hollow conductor bars. Restricted spray orifices are provided in communication with the hollow conductor bars to provide a spray of cooling fluid towards other generator components. The restricted orifices are configured to have a flow area (A′) that is less than the average flow area (B′) of the respective first hollow conductor bar such that, in use, the flow of cooling fluid through the outlet end of the plurality of first hollow conductor bars is balanced with cooling fluid delivered to the annular sump volume to maintain a flow of fluid through the respective fluid conduits.

### TECHNICAL FIELD

The present invention relates to an electric machine and particularly, though not exclusively, to an electrical generator for a wind turbine.

### BACKGROUND TO THE INVENTION

Wind turbines convert kinetic energy from the wind into electrical energy, using a large rotor with a number of rotor blades. A typical Horizontal Axis Wind Turbine (HAWT) comprises a tower, a nacelle on top of the tower, a rotor hub mounted to the nacelle and a plurality of wind turbine rotor blades coupled to the rotor hub. Depending on the direction of the wind, the nacelle and rotor blades are turned and directed into an optimal direction by a yaw system for rotating the nacelle and a pitch system for rotating the blades.

The nacelle houses many functional components of the wind turbine, including for example a main rotor shaft and one or more electrical generators, as well as convertor equipment for converting the mechanical energy at the rotor into electrical energy for provision to the grid. In some types of wind turbines, known as ‘direct drive’ systems, the main rotor shaft drives the electrical generator directly. However, it is more common for wind turbines to include a gearbox to step up the rotational speed between the main rotor shaft and the electrical generator, thus converting the low speed but high torque input from the main rotor shaft to a lower torque but higher speed input into the electrical generator. Together, the main rotor shaft, gearbox and generator constitute a power train of the wind turbine.

The electrical generator of a wind turbine is a type of electric machine. One type of electric machine known in such applications is known as a squirrel cage singly fed induction generator which comprises a rotor having a plurality of conductor bars arranged circumferentially relative to one another like the bars of a squirrel cage. The rotor is mounted for rotation within a stator having a set of windings which are excitable with a suitable AC waveform. Interaction between the stator windings and the driven rotor results in power being generated.

A problem associated with electric machines is that they generate heat during operation which needs to be managed appropriately. This problem is particularly acute in high power applications.

One known approach is to use air-cooling principles to blow cooled air over the windings and/or the rotor bars to dissipate thermal energy. However, this approach has limited effectiveness since air is an inefficient carrier of thermal energy.

Another known approach is to integrated liquid cooling into the electric machine. One way of doing this is to feed a cooling liquid such as oil through a rotor core of the electric machine. Thermal energy generated in the conductor bars therefore dissipates into the rotor core and, therefore, into the cooling oil. As a development of this theme, it is also known to configure the rotor bars of the induction generator to be hollow and to feed them with cooling oil from a suitable cooling circuit which draws away thermal energy from the conductor bars.

Although the known approaches do provide effective the thermal management of induction machines, there is further scope for improvement. It is against this background that the examples of the invention have been devised.

### SUMMARY OF THE INVENTION

According to a first aspect of the invention, there is provided an electric machine in accordance with Claim 1.

The examples of the invention extend to a wind turbine comprising a tower and a nacelle mounted on top of the tower, wherein the nacelle houses a powertrain comprising a rotor that drives a generator in the form of an electrical machine as defined above.

The examples of the invention provide a means for cooling the conductor bars associated with the rotor core and also the end plates that provide short circuit rings. Moreover, the configuration of the first and second end plates that provide the rotating sump volume, and the restricted orifice from which fluid spray is issued, means that a steady flow of cooling fluid is maintained through the fluid conduits of the first plurality of hollow conductor bars and that no dry spots or air cavities are formed. Beneficially, cooling fluid in the rotating sump volume experiences centrifugal force during rotation of the rotor which generates fluid pressure within the hollow conductor bars. The selective sizing of the relative areas of the restricted orifices and the fluid conduits means that the fluid flow into and out of the fluid conduits is largely balanced during use. The rotating sump volume may be adapted to accommodate a variable level of cooling fluid therein which means that a wider range of rotational speeds is accounted for. At low rotational speeds, when induced currents in the conductor bars is generally lower, which therefore means less heat is generated, the cooling fluid may flow at a lower rate due to the lower pressure generated in the rotating sump volume. Conversely, at higher rotational speeds, the rotating sump volume will generate higher fluid pressures which will cause a higher flow rate and a great spray volume from the restricted orifices to cool the stator windings. The system therefore has a degree of self-regulation.

Preferred and/or optional features are provided in the dependent claims.

### BRIEF DESCRIPTION OF THE DRAWINGS

The present invention will now be described, by way of example only, with reference to the attached drawings, in which:

FIG. 1 is a perspective view of a horizontal-axis wind turbine within which the invention may be incorporated;

FIG. 2 is a schematic view of a power generation system for a wind turbine, including a generator comprising a stator and a rotor;

FIG. 3 is a perspective view of a rotor in accordance with an example of the invention that may be incorporated into the power generation system of FIG. 2;

FIG. 4 is a longitudinal section view of the rotor of FIG. 3;

FIG. 5 is a schematic view of the generator shown in FIG. 2; including the rotor of FIGS. 3 and 4;

FIGS. 6 and 7 are schematic views of conductor bars of the rotor shown in FIG. 5, illustrating the flow direction of cooling fluid through different rows of conductor bars.

### DETAILED DESCRIPTION

A specific embodiment of the present invention will now be described in which numerous features will be discussed in detail in order to provide a thorough understanding of the inventive concept as defined in the claims. However, it will be apparent to the skilled person that the invention may be put into effect without the specific details and that in some instances, well known methods, techniques and structures have not been described in detail in order not to obscure the invention unnecessarily.

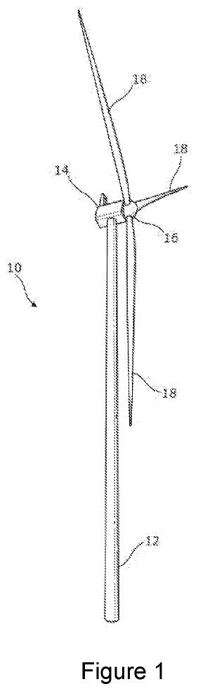

In order to place the embodiments of the invention in a suitable context, reference will firstly be made to FIG. 1, which illustrates a typical Horizontal Axis Wind Turbine (HAWT) in which a generator rotor assembly according to an embodiment of the invention may be implemented. Although this particular image depicts an on-shore wind turbine, it will be understood that equivalent features will also be found on off-shore wind turbines. In addition, although the wind turbines are referred to as ‘horizontal axis’, it will be appreciated by the skilled person that for practical purposes, the axis is usually slightly inclined to prevent contact between the rotor blades and the wind turbine tower in the event of strong winds.

The wind turbine 10 comprises a tower 12, a nacelle 14 rotatably coupled to the top of the tower 12 by a yaw system (not shown), a rotor hub 16 mounted to the nacelle 14 and a plurality of wind turbine rotor blades 18 coupled to the rotor hub 16. The nacelle 14 and the rotor blades 18 are turned and directed into the wind direction by the yaw system.

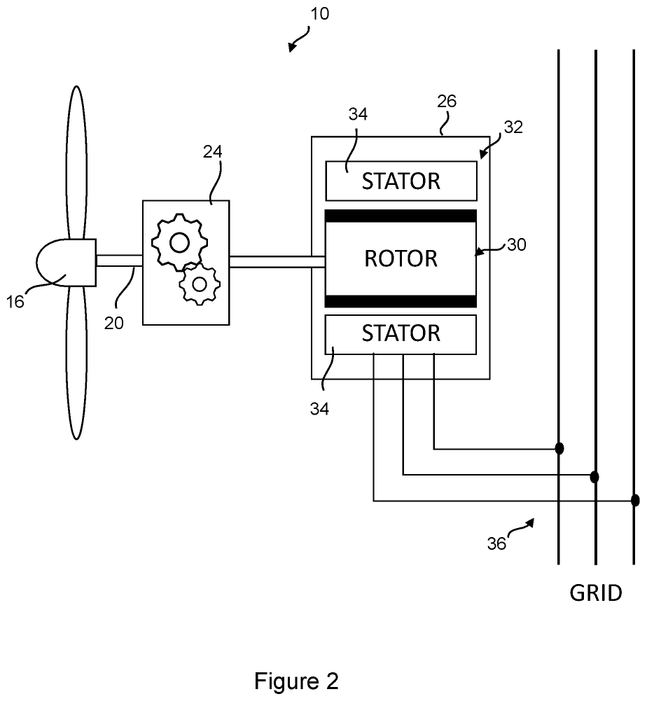

The nacelle 14 houses many functional components of the wind turbine 10, including the main rotor shaft, generator, gearbox, and power converter for converting the mechanical energy of the wind into electrical energy for provision to the grid. FIG. 2 illustrates a schematic view of a number of wind turbine components, including a main shaft 20, a gearbox 24 and a generator 26. The main shaft 20 is connected to, and driven by, the rotor hub 16 and provides input drive to the gearbox 24.

As will be appreciated in FIG. 2, the generator 26 is in the form of a squirrel-cage type synchronous induction machine which comprises a rotor 30 that is rotatably mounted within a stator 32. The stator includes a set of stator windings 34 that surround the rotor and serve to establish a rotating magnetic field when suitably energised by alternating current. The stator windings 34 are connected to a power grid 36. This configuration is known to those skilled in the art so a detailed discussion will be omitted.

At this point, it is worth noting that cooling of induction generators can be challenging because the rotor is in the rotating reference frame. Furthermore, conventional air-cooling can be undesirable because it requires the rotor to be configured with suitable air ducting throughout its structure which reduces the amount of magnetically active material in any design for a given overall rotor length.

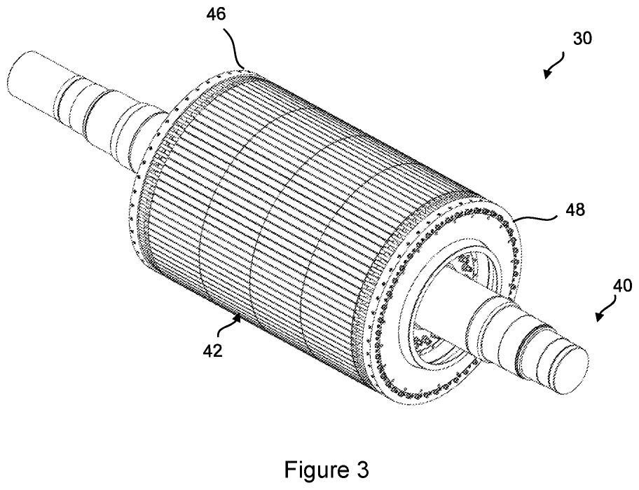

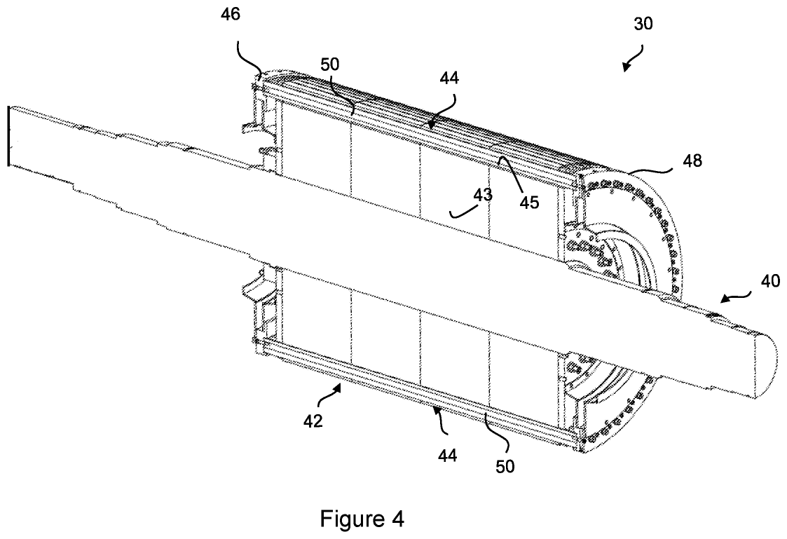

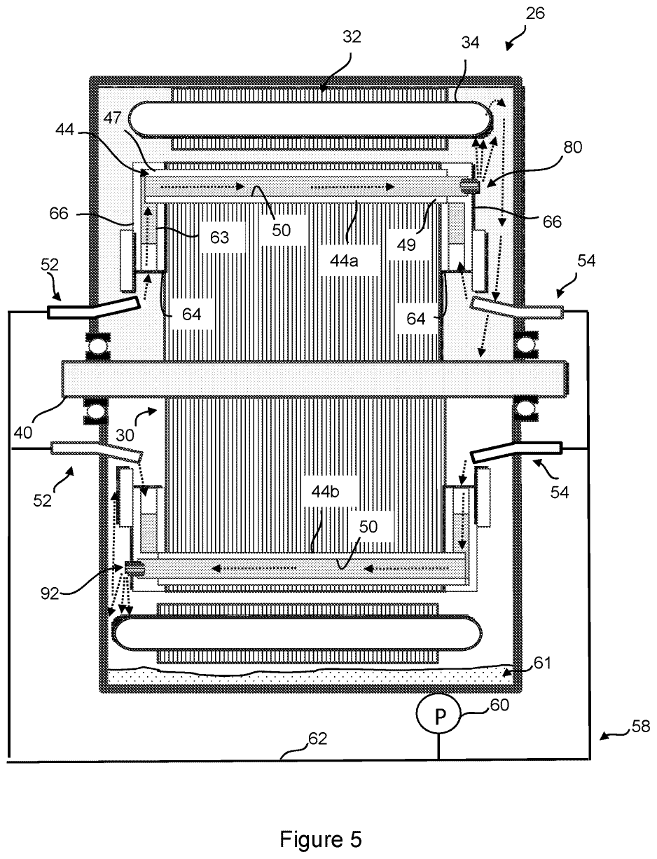

Aspects of the generator 26 are shown in more detail in FIGS. 3 to 5. In these Figures, the rotor 30 is depicted in isolation in FIGS. 3 and 4 and a schematic view of the rotor 30 and stator 32 is depicted in FIG. 5.

The generator 26 is of the type generally known as an induction machine and as such the rotor includes a rotor shaft 40 and a rotor core 42. The rotor core 42 is rotationally fixed on the rotor shaft 40 so that torque applied to the rotor shaft 40 by a prime mover is transmitted to the rotor core 42. The rotor core 42 is made from rotor laminations (not shown in FIGS. 3 and 4, for clarity) as is generally known in the art and defines a radially inner cylindrical passage 43 through which passes the rotor shaft 40. In some examples, the rotor core 42 is an integral part of the rotor shaft 40 and there is no specific shaft component that passes through the rotor core 42.

A radially outer region of the rotor core 42 supports or carries a plurality of conductor bars 44, which are received in axial slots 45 defined by the rotor core 42, as is generally conventional. It is the conductor bars 44 that are excited by the electromagnetic field generated in the stator windings 34 which therefore induce electrical currents in the conductor bars 44. Either ends of the conductor bars 44 are bounded by respective first and second short-circuit rings 46,48.

The generator 26 is configured with a cooling system for cooling the rotor 30. With respect to the rotor, the cooling system includes a plurality of fluid conduits 50 each of which is defined by a respective one of the conductor bars 44 since they are configured to be hollow, as can be appreciated particularly in FIGS. 4 and 5.

The fluid conduits 50 extend along the length of the conductor bars 44 from one end of the rotor 30 to the other end.

As will be made clear in the discussion that follows, the flow of cooling fluid or coolant through the conductor bars 44 in the rotor is bi-directional, such that in some of the conductor bars 44 the coolant flows within them in a first direction, e.g. left to right as seen in the Figures, whereas in other ones of the conductor bars 44 coolant flows along them in a second direction, e.g. right to left as seen in the Figures. This generally improves the cooling potential of the cooling system. As will also be appreciated in the following discussion, the first and second short circuit rings 46,48 are adapted to function as a rotating sump volume so as to feed coolant to the fluid conduits 50 of the conductor bars 44.

Beneficially, and as will be appreciated in the following discussion, the conductor bars are cooled by coolant flowing in the hollow internal channels, and, moreover, the short circuit rings 46,48 are also cooled by the presence of coolant collected therein as a function of them providing a rotating sump volume. Any suitable coolant may be used, such as cooling oil.

Whereas FIGS. 3 and 4 show perspective views of the rotor 30, FIG. 5 shows a schematic view of the generator 26. It should be noted that in FIG. 5, both types of conductor bar 44 can be identified, namely a conductor bar 44a of the first group in which cooling fluid flows in the first direction, i.e. left to right as seen in FIG. 5, and a conductor bar 44b of a second group in which cooling fluid flows in the second direction, i.e. right to left as seen in FIG. 5. Note that conductor bar 44a is shown in the upper half of FIG. 5 whereas conductor bar 44b is shown in the lower half of FIG. 5.

As has been mentioned above, the conductor bars 44 extend between the first short circuit ring 46 and the second short circuit ring 48. As such, a first end 47 of the conductor bar 44 is received by, abuts or is connected to the first short circuit ring 46, and a second end 49 of the conductor bar 44 is received by, abuts, or is connected to the second short circuit ring 48. The respective ends 47,49 of the conductor bars 44 are therefore electrically connected to the short circuit rings 46,48.

The short circuit rings 46,48 are adapted to serve as a rotating annular sump volume for accommodating cooling fluid and supplying that cooling fluid to the conductor bars 44 under pressure in a controlled manner. Cooling fluid is supplied to the first short circuit ring 46 and the second short circuit ring 48 by a respective set of fluid supply nozzles 52,54.

By virtue of the short circuit rings 46,48 acting as sump volumes, cooling fluid is supplied directly to the magnetically active material which cools the short circuit rings 46,48 directly and, therefore, more effectively.

The fluid supply nozzles 52,54 form part of a supply circuit 58. The supply circuit 58 includes a pump 60 which draws off cooling fluid that has pooled at the bottom of the generator 26. The pump 60 is connected to appropriate pipework 62 that feeds cooling fluid 61 to the fluid supply nozzles 52,54 under a suitable pressure. It should be appreciated that the supply circuit 58 is shown here in schematic form so other configurations are acceptable. For example, FIG. 5 shows cooling fluid that has pooled in the bottom of the generator 26, which therefore forms a stationary vessel or sump for the cooling fluid. However, it may be desirable to provide the generator 26 with an external sump.

Each of the short circuit rings 46,48 is shaped to define a radial chamber 63 between a respective first axial plate 64 and a second axial plate 66. The radial chamber 63, bounded axially by the ring plates 64,66, serves to retain cooling fluid therein by centrifugal force as the rotor 30 rotates, thereby providing a rotating sump volume. The fluid pressure generated by this action cause the cooling fluid to flow through the conductor bars 44 from one end to the other, therefore providing a cooling effect.

In this example, since cooling fluid flows through the conductor bars 44 in alternating directions, it is the case that the conductor bars 44a of the first group are in fluid communication with the radial chamber 63 defined by the first short circuit ring 46, whereas the conductor bars 44b of the second group are in fluid communication with the radial chamber 63 defined by the second short circuit ring 48.

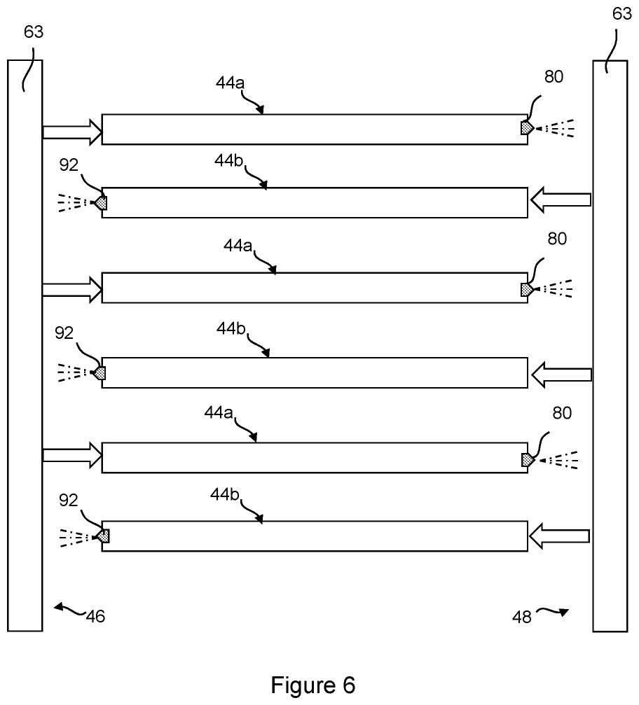

This arrangement can also be appreciated further by viewing FIG. 6 which shows a number of the conductor bars 44a,44b of the rotor 30 arranged in a row, so the alternate spacing of the different conductor bars 44a,b is clearly demonstrated. It will be noted therefore in this example that the conductor bars 44a of the first group are interdigitated with the conductor bars 44b of the second group. It should be noted that although FIG. 6 shows a strict alternation in the flow direction between adjacent ones of the conductor bars, it is envisaged that the conductor bars may be arranged in different groups, for example so that two or more adjacent conductor bars 44 may have a fluid flow in one direction, and that the next two or more adjacent conductor bars have an opposite fluid flow direction.

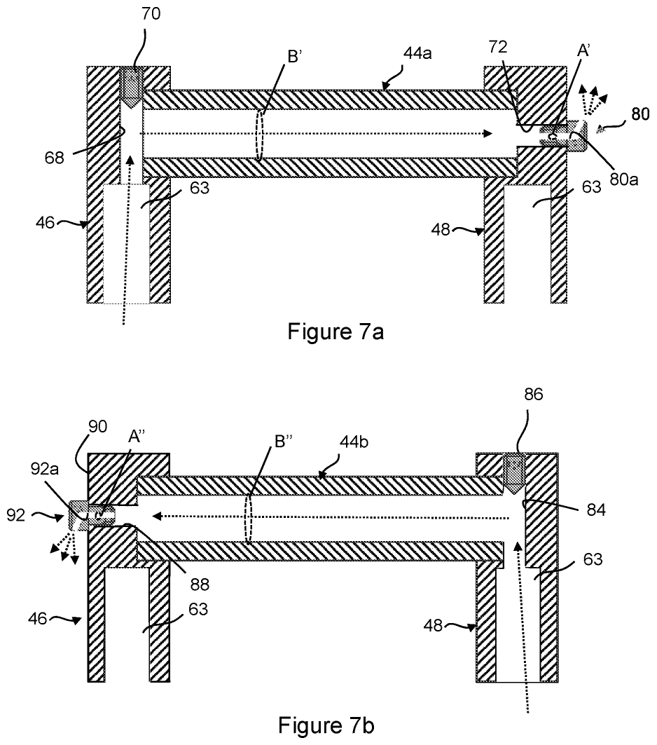

Returning to FIG. 5, but also with reference to FIGS. 7a and 7b, which show the conductor bars 44a,44b of each group in more detail, it will be appreciated from FIGS. 5 and 7a that the conductor bars 44a of the first group defines a respective fluid conduit 50 which is in communication with the radial chamber 63 defined by the first short circuit ring 46.

The fluid conduit 50 extends to each open end of the conductor bar 44a. Since the conductor by is received in and supported by the first and second short circuit rings 46,48, the fluid conduit 50 communicates with passageways defined within the short circuit rings 46,48.

A first one of these passageways, labelled 68 in FIG. 7a, extends radially outward from the radial chamber 63 and through the first short circuit ring 46. The passageway 68 penetrates the outer surface of the first short circuit ring 46 and is closed by a suitable closure 70 such as a stopper or bung.

A second passageway 72 is formed in the second short circuit ring 48. The second passageway 72 extends in an axial direction and penetrates an axial end surface 74 of the second short circuit ring 48. The opening of the second passageway 72 is closed by a spray nozzle 80. The spray nozzle 80 provides a restricted orifice 80a which serves to generate a spray of cooling fluid based on the pressure that is generated by the fluid head in the radial sump of the first short circuit ring 46.

As can be seen in FIG. 5, the spray nozzles 80 may be configured to direct cooling fluid towards the end of the stator windings 34, as indicated by the dotted arrows. The cooling fluid then falls under gravity to the bottom of the generator 26 where it returns to the fluid supply system 58. In other examples, it is envisaged that the spray nozzles 80 may be adapted to direct a spray of cooling fluid towards at least another component of the generator 26.

Since there are multiple conductor bars 44a of the first group in the rotor 30, the first short circuit ring 46 defines a plurality of such first passageways 68 that feed cooling fluid to respective conductor bars 44a. Similarly, the second short circuit ring 48 is provided with a plurality of second passageways 72 that fluidically connect the conductor bars 44a to the respective spray nozzles 80.

In order to generate a suitable spray pattern, the restricted orifice in the spray nozzle 80 has a narrow form which defines a flow area labelled as A′, as indicated in FIG. 7a, and as indicated as A″ in FIG. 7b. It will be noticed that the flow area A′, A″ is less than the average flow area, labelled B′ in FIG. 7a and B″ in FIG. 7b, of the fluid conduit 50 provided by the conductor bar 44a. More specifically, the flow area A′, A″ is envisaged to be less than 20% of the respective average flow area B′, B″. For example, the flow area A′, A″ may be less than 15%, or less than 10% or less than 5% of the respective flow area B′, B″.

In this discussion, references to ‘flow area’ can be considered to be the cross section area of the relevant flow passage perpendicular to the direction of flow, that is, the axis of the conductor bars 44. Also, it should be noted that the flow area A′ of the restricted orifice 80a in FIG. 7a and the flow area A″ of the restricted orifice 92a in FIG. 7b may be different cross sectional areas. However, in the illustrated examples the two different flow areas A′ and A″ are the same. Similarly, the average flow area B′ of the conductor bar 44a in FIG. 7a is shown here as being the same as the average flow area B″ of the conductor bar 44b in FIG. 7b. However, the two average flow areas B′ and B″ of the respective fluid conduits of the different conductor bars 44a and 44b may be different.

The restricted flow area A compared to the flow area B of the conductor bar 44a provides a balance between permitting cooling fluid to be sprayed out of the nozzle 80 and allowing a sufficient volume of cooling fluid to be accumulated in the radial chamber 63 or sump of the first short circuit ring 46. Under normal operating conditions of the rotor, the rotation of the rotor 30 generates a centrifugal action on the fluid in the radial chamber 63.

In the context of the flow area B of the conductor bar 44a, it should be noted that the uniformity of the fluid conduit 50 provided in the conductor bar 44a means that the flow area B is the same along the length of the conductor bar 44a. However, it is envisaged that the internal profile of the fluid conductor 50 may not be uniform along its axial length. Therefore, the flow area B of the conductor bar 44a should be considered as the average flow area along the length of the fluid conduit 50 of the conductor bar 44a. For example, this could be calculated by determining the flow areas at multiple points, (e.g. between 5 and 20 measurement points) along the conductor bars 44a and then dividing the result by the number of measurement points. It should be noted at this point that in the context of induction generators and similar electric machines, the magnetically active elements such as conductor bars and short circuit rings are typically made from a material with high electrical conductivity, and also high magnetic permeability, such as copper or aluminium. Such materials usually also exhibit high thermal conductivity. This means that the configuration of the conductor bars, and specifically their hollow internal profile, is relatively insensitive to variation, and the high thermal conductivity will tend to minimise any thermal variation.

FIGS. 5 and 7b illustrate a conductor bar 44b of the second group. As can be seen, the direction of fluid flow through the fluid conduit 50 of the conductor bar 44b is opposite to the flow direction of the conductor bar 44a of the first group.

It will be appreciated here that the configuration of the conductor bar 44b, the first short circuit ring 46 and the second short circuit ring 48 is, in effect, the mirror of that shown in FIG. 7a. As such, the conductor bar 44b is received in and supported by the first and second short circuit rings 46,48, such that the fluid conduit 50 of the conductor bar 44b communicates with passageways formed within the short circuit rings 46,48.

A third one of the passageways, labelled as 84 in FIG. 7b, extends radially outward from the radial chamber 63 and through the second short circuit ring 48. The third passageway 84 penetrates the outer surface of the second short circuit ring 48 and is closed by a suitable closure 86.

A fourth one of the passageways 88 is formed in the first short circuit ring 46. The fourth passageway 88 extends in an axial direction through the first short circuit ring 46 and penetrates an axial end surface 90. The opening of the fourth passageway 88 is closed by a spray nozzle 92. The spray nozzle 92 provides a restricted orifice 92a which generates a spray of cooling fluid as discussed above in respect to the spray nozzles 80 of the first group of conductor bars 44a. The same geometrical details apply and so will not be discussed further here.

Considering the above discussion of the action of the radial chambers 63, the fluid conduits 50 in the conductor bars 44a,b, and the outlet nozzles 80,92, it should be appreciated that equilibrium pressure conditions exist when the centrifugal pressure of fluid in the radial chambers 63 is substantially equal to the pressure drop across the outlet nozzles 80,92 of the rotor 30 which, in essence, means that the same or a similar volume of cooling fluid is flowing out of the nozzles 80, 92 as is being delivered to the radial chambers 63. Notably, the spinning action of the radial chambers 63 generating a pressure head in the cooling fluid means that all internal passages in the short circuit rings 46,48 and the conductor bars 44a,44b are filled with cooling fluid which avoids trapped air, which could otherwise result in hot spots within the conductor bars 44,4a,44b. Also, advantageously the presence of the radial chambers 63 means that the cooling fluid is in direct contact with the respective short circuit rings 46,48 which maximises thermal transfer between the thermally conductive material of the short circuit rings 46,48 and the cooling fluid.

Notably, the depth of the radial chambers 63, as defined by the walls of the respective first and second short circuit rings 46 means that the fluid level in the radial chambers 63 can vary significantly whilst still permitting uninterrupted flow of cooling fluid from the outlet nozzles 80,92. So, the varying fluid level in the radial chambers 63 is able to accommodate a useful wide range of rotational speeds of the rotor 30. In the event that the radial chambers 63 do overflow, any overspilling cooling fluid will be flung radially outwards towards the windings 34 of the generator 26.

The skilled person would appreciate that various modifications may be made to the examples discussed above without departing from the inventive concept as defined by the claims.

For example, in the illustrated examples, the restricted orifices 80a,92a are provided by the respective nozzles 80,92 as this is a convenient way of providing the required structure. What is more, the geometry and spray direction of the restricted orifices 80a,92a can be changed by changing the nozzles 80,92. In other examples, however, the restricted orifices 80a,92a may be provided by other means, for example by suitable drillings provided in the respective short circuit rings 46,48.

In the illustrated examples the conductor bars 44 each include a single fluid conduit through which cooling fluid flows in a single direction. However, it should be appreciated that this structure could be enhanced so that the conductor bars 44 include more than one fluid conduit, for example two or more fluid conduits, such as between two and ten, or between two and five fluid conduits. Suitable structural adjustments may be made to the hydraulic configuration of the short circuit rings to permit cooling fluid to flow in the same direction or in different directions through the plurality of fluid conduits provided in each of the conductor bars 44. Still further, in the illustrated examples it will be noted that the hydraulic configuration of the short circuit rings and the conductor bars is such that the cooling fluid flows in parallel through the conductor bars. However, suitable hydraulic adaptations may be made so that cooling fluid flows instead in series through two or more of the conductor bars 44.

1. An electric machine comprising:
a stator including stator windings, and a rotor;
wherein the rotor includes a rotor core mounted on a shaft, and a plurality of first hollow conductor bars carried by the rotor core, wherein each of the first hollow conductor bars has a first bar end and a second bar end and a fluid conduit extending between the first and second bar ends;
wherein each first hollow conductor bar is configured such that the respective fluid conduit has an average flow area (B′) along its length,
the electrical machine further comprising:
a first short-circuit ring proximate the first bar ends of the plurality of first hollow conductor bars, and a second short-circuit ring proximate the second bar ends of the plurality of first hollow conductor bars,
wherein the first short-circuit ring is configured to define an annular sump volume, and wherein first short-circuit ring is configured such that the annular sump volume is in fluid communication with an inlet end of each respective fluid conduit of the plurality of first hollow conductor bars;
wherein an outlet end of each of the plurality of first hollow conductor bars, feeds a respective first restricted orifice,
wherein the respective first restricted orifice is configured to have a flow area (A′) that is less than the average flow area (B′) of the respective fluid conduit of the respective first hollow conductor bar, such that, in use, the flow of cooling fluid through the outlet end of the plurality of first hollow conductor bars is balanced with cooling fluid delivered to the annular sump volume to maintain a flow of fluid through the respective fluid conduits.

2. The electric machine of claim 1, wherein the flow area (A′) of the restricted orifices is less than 20% of the average flow area (B′) of the respective fluid conduit of the respective first hollow conductor bar.

3. The electric machine of claim 1, wherein at least some of the restricted orifices are configured to spray cooling fluid carried by the first hollow conductor bars towards the stator windings.

4. The electric machine of claim 3, wherein at least some of the restricted orifices are configured to spray cooling fluid towards at least one component of the electric machine other than the stator windings.

5. The electric machine of claim 1, further comprising a fluid supply nozzle configured to spray cooling fluid into the rotating sump volume of the first short-circuit ring from a stationary reference frame.

6. The electric machine of claim 1, wherein the first short-circuit ring includes annular fluid retention plates which define, at least in part, the rotating sump volume.

7. The electric machine of claim 1, further comprising:
a plurality of second hollow conductor bars carried by the rotor core, each of the second hollow conductor bars having a first bar end, a second bar end and a fluid conduit extending between the first and second bar ends,
wherein each second hollow conductor bar is configured such that respective fluid conduit has an average flow area (B″) along its length,
wherein, the second short-circuit ring defines a respective annular sump volume and is configured such that the second annular sump volume is in fluid communication with an inlet end of each respect second fluid conduit of the second plurality of hollow conductor bars, and
wherein an outlet end of each of the plurality of second hollow conductor bars feeds a respective second restricted orifice, wherein the respective second restricted orifice is configured to have a flow area (A″) that is less than the average flow area (B″) of the respective fluid conduit of the respective second hollow conductor bar, such that, in use, the flow of cooling fluid through the outlet end of the plurality of second hollow conductor bars is balanced with cooling fluid delivered to the annular sump volume to maintain a flow of fluid through the respective fluid conduits.

8. The electric machine of claim 7, wherein the restricted orifice is configured to have a flow area that is less than 20% of the average flow area (B″) of the respective fluid conduit of the respective second hollow conductor bar.

9. The electric machine of claim 7, wherein the plurality of second hollow conductor bars are interdigitated with the plurality of first hollow conduct bars, when considered in a circumferential direction about the rotor core.

10. The electric machine of claim 9, wherein the flow direction of fluid through the plurality of first hollow conductor bars is opposite to the flow direction of fluid through the plurality of first hollow conductor bars.

11. The electric machine of claim 1, further comprising a fluid supply circuit configured to supply coolant to the annular sump volume of the first short-circuit ring.

12. The electric machine of claim 11, wherein the fluid supply circuit comprises a fluid supply nozzle in a stationary reference frame with respect to the rotor that is configured to spray coolant to the annular sump volume of the first short-circuit ring.

13. The electric machine of claim 11, when dependent on claim 7, wherein the fluid supply circuit is configured to supply coolant to the annular sump volume of the second short-circuit ring.

14. The electric machine of claim 13, wherein the fluid supply circuit comprises a fluid supply nozzle in a stationary reference frame with respect to the rotor that is configured to spray coolant to the annular sump volume of the second short-circuit ring.

15. A wind turbine comprising a tower and a nacelle mounted on top of the tower, wherein the nacelle houses a rotor that drives a generator in the form of an electrical machine as claimed in claim 1.
